(19) United States
(12) Patent Application Publication
(10) Pub. No.: US 2015/0046327 A1
(43) Pub. Date: Feb. 12, 2015

(54) SERVER-BASED PAYMENT SYSTEM

(71) Applicant: Cashcloud AG, Luxembourg (LU)

(72) Inventor: Olaf Taupitz, Luxembourg (LU)

(21) Appl. No.: 13/961,118

(22) Filed: Aug. 7, 2013

(51) Int. Cl. G06Q 20/22; G06Q 20/40

(52) U.S. Cl. CPC G06Q 20/227; G06Q 20/40
USPC 705/44

(57) ABSTRACT

A server based payment system for creating a transaction are provided, where a user can transfer electronic money to recipients selected from contact lists at one or more web based communication platforms. An access token is generated, which contains identity and privileges associated with a preexisting web-based user account. The system uses the received access token to retrieve a stored contact list for the user account. The contact list is processed to determine whether corresponding user accounts exist in the system. A processed contact with entries for which corresponding user accounts exist is sent to a user terminal. At the user terminal, a payment order is generated by selecting an entry from the list and indicating an amount to be transferred, and is transmitted to the system. A transaction is created that includes a data record with the amount to be paid, as well as initiator, and remittee.

### FIELD OF THE INVENTION

The present invention relates to the field of network service applications and, more particularly, to a server-based payment system, a programmable user terminal programmed to communicate with a server-based payment system, and a related method of creating a transaction at a server-based payment system.

### BACKGROUND OF THE INVENTION

In addition to classical cash transactions, virtual transactions of electronic money gain increasing importance in the context of modern telecommunication networks, in particular the Internet. Online payment systems exist, where registered users can exchange cashless payments, i.e. receive from or transfer to other registered users electronic money payments. In order to make an electronic payment, a user has to identify a recipient of the payment and an amount of money to be transferred. The recipient can typically be identified by his e-mail address. The amount is then either charged from a prepaid account of the user managed by the payment service provider or debited from a bank account of the user with which he has registered at the online payment system. However, in order to make such payments, the user has to know whether the intended recipient is also a registered user of and has therefore a user account with the same online payment system.

### SUMMARY OF THE INVENTION

It is an object of a present invention to provide a server-based payment system and related method of creating a transaction at the server-based payment system, which is easier to use and in particular well suited for electronic money transfer among friends or for over-the-counter payments.

These and other objects that appear below are achieved by a server-based payment system and related methods of creating a transaction, where a user can transfer electronic money (often referred to as e-money) to recipients selected from contact lists he has at one or more web-based communication platforms, often also termed social networks.

According to an embodiment, a method of creating a transaction at a server-based payment system, which is adapted to administrate a plurality of payment service user accounts, contains the following steps. First, an access token will be generated, which contains information about an identity and privileges associated with a social network user account that pre-exists at a web-based communication platform. The access token is transmitted to the server-based payment system. The server-based payment system uses the received access token to retrieve a contact list stored at the web-based communication platform for the social network user account. The contact list is then processed to determine whether corresponding payment service user accounts exist at the server-based payment system for entries of the contact list. A processed contact list is then transmitted to a user terminal. The processed contact list contains for entries, for which corresponding payment service user accounts exist, information indicative thereof. At the user terminal, a payment order is generated by selecting an entry from the processed list and indicating an amount to be transferred. That payment order is transmitted to the server-based payment system, where a transaction is created and stored in a database of the server-based payment system. The transaction includes in the form of a data record the amount to be paid, as well as initiator, and remittee as indicated by the payment order.

Preferably, in order to create the access token, the server-based payment system redirects an existing connection from the user terminal to an authorization link of the web-based communication platform, user credentials are transmitted from the user terminal to the authorization link, and the web-based communication platform generates the access token.

In addition to using a contact list from a web-based communication platform, a local contact list, i.e., a list taken from the local address book, can be transmitted from the user terminal to the server-based payment system, where the lists are consolidated, and a processed contact list is returned to the user terminal, which list contains consolidated entries from the retrieved contact list and from the local contact list.

According to a further variant, the server-based payment system can retrieve contact lists from two or more different web-based communication platforms using different access tokens generated at the corresponding communication platforms, consolidate the two or more contact lists, and return to the user terminal a processed contact list containing consolidated entries from the two or more retrieved contact lists.

In the case that no payment service user account exists so far for the remittee, the server-based payment system creates a temporary user account entry, assigns a pending registration status to the entry and transmits an invite message to the remittee using contact information contained in the payment order. The invite message contains a unique registration identifier and a link to a registration page. Upon registration of the remittee at the registration link, the server-based payment system validates the user entry by creating a new payment service user account for the remittee and assigns the transaction to the newly created account.

If a payment service user account of the remittee exists, the server-based payment system assigns a pending acceptance status to the transaction and transmits a notify message to the remittee. The notify message contains information about the pending transaction.

After the remittee connects to the server-based payment system to accept the pending transaction, the transaction is executed, account balances of the initiator's and the remittee's accounts are changed accordingly, and an accepted status is assigned to the transaction.

In another embodiment, a server-based payment system is provided, which contains at least one host computer, an executable server application for administrating a plurality of payment server user accounts, and a data storage for storing user account data in the form of data records. The server application is programmed to perform, when run on the at least one host computer, the following actions: Upon receipt of an access token which contains information about an identity and privileges associated with a social network user account that exists at a web-based communication platform, the host computer uses the access token to retrieve a contact list stored at the web-based communication platform for the social network user account. The host computer further processes the contact list to determine whether corresponding payment user accounts exists at the server-based payment system for entries of the contact list. The host computer then transmits to a user terminal a processed contact lists, which contains information indicative of those entries for which a corresponding service user account exists. Upon receipt of a payment order generated at the user terminal by selecting an entry from the process contact lists and indicating an amount to be transferred, the host computer creates a transaction and stores the transaction on the data storage. The transaction includes in the form of a data record the amount to be paid, as well as the initiator and the remittee as indicated by the payment order.

In a further embodiment, a programmable user terminal is provided, which contains an application program for communicating with a server-based payment system. The application program is programmed to perform, when executed by the programmable user terminal, the following actions: The programmable user terminal initiates generation of an access token which contains information about an identity and privileges associated with a social network user account that exists at a web-based communication platform by transmitting user credentials entered by a user into an input mask displayed to the user by the terminal. The user terminal receives from the server-based payment system a processed contact list which contains entries taken from a contact list belonging to the social network user account at the web-based communication platform as well as information indicative of whether corresponding payment service user accounts exists at the server-based payment system. The user terminal displays to the user a menu for the selection of a payment remittee from the processed contact list and for entering an amount to be transferred to the remittee. The user terminal further transmits to the server-based payment system a payment order which contains information indicative of an entry selected from the processed contact list and the amount to be transferred.

In a yet another embodiment a programmable user terminal is provided, which contains an application program for communicating with a server-based payment system. The application program is programmed to perform, when executed by said programmable user terminal, the following actions: The terminal performs a login with a web-based communication platform by transmitting user credentials entered by a user into an input mask displayed to the user by the terminal. The terminal then retrieves from the web-based communication platform a contact list belonging to a social network user account, which account preferably belongs to the same user who uses the terminal. A menu is then displayed to the user for the selection of a payment remittee from the contact list. Moreover, the terminal transmits to the server-based payment system a payment order that contains information indicative of an entry selected from said contact list, information indicative of the web-based communication platform and an amount to be paid.

By enabling the user to access contact lists from his social network accounts, the present invention provides a very comfortable way for the user to select a recipient for an e-money transfer. On the other hand, by preprocessing the contact lists at the server of the payment system and flagging entries for users who already have a payment service user account at the payment system, the user will know, to which of his contacts he can easily and securely transfer electronic payments. The present invention is therefore perfectly suited for payments among friends on social networks.

### BRIEF DESCRIPTION OF THE DRAWINGS

Embodiments of the present invention will now be described with reference to the accompanying drawings, in which

FIG. 1 shows communication between user terminals, a server-based payment system, and servers of social networks;

FIG. 2 shows a flowchart for the generation of an access token;

FIG. 3 shows message flow between a user terminal, a server of the payment system, and a server of the communication platform to obtain an access token;

FIGS. 4a, b show a flowchart for the generation of a transaction at a payment system;

FIGS. 5a, b show a flowchart of the processing of a transaction at the payment system;

FIG. 6 shows the menu structure of an app installed on a user's smart phone;

FIG. 7 shows message flow for a login from a user terminal to Facebook via a web portal of the payment system; and

FIG. 8 shows message flow for a direct login of an application installed on a user terminal to Facebook.

### DETAILED DESCRIPTION OF PREFERRED EMBODIMENTS

The embodiments described below relate to an online service, which is provided through a communication network such as the internet. In order to access this online service, a dedicated application program, commonly called an app, has to be installed on a user terminal such as a smartphone, a tablet PC, or the like, which communicates with the servers of the service provider. As an alternative, the service can also be implemented as a web portal that can be accessed from a user terminal by means of a conventional web browser.

The system of the service provider contains a server platform that has installed and runs a server application, which administrates user related data records stored on a data storage. The server platform contains at least one, but preferably a plurality of interconnected server computers, which are also termed server hosts, and are as such of conventional design well-known to those skilled in the art. In particular, the server platform can be a server farm or server cluster, i.e., a collection of computer servers of similar design, which in order to distribute computing workload and provide redundancy are interconnected, to form a unitary virtual system.

The data storage can be connected to the server platform or can be integrated in one or more of the server hosts. The data storage can also be implemented as a distributed storage system and can be structured as a database.

The service as such is an electronic payment service, which includes the administration of user accounts for electronic money, the management of user deposits, as well as transfer and receipt of electronic payments among registered users of the payment service.

User accounts are kept on the basis of deposit accounts, meaning that the user can top up his user account with money from a credit card or a normal bank account and can then use this money for electronic payment transactions. However, transactions can only be made up to a maximum of the available account balance. An additional limit for transactions can also be defined, which is below the available account balance, in order to limit the risk of fraudulent use.

Moreover, the user can also withdraw again his credit balance from the user account and transfer it back to his normal bank account or credit card account. In order to make an electronic money transfer, a user only has to indicate a registered user to whom the money shall be transferred, hereinafter called the remittee, and an amount to be transferred. The respective amount will then be debited from the user account of the initiating user, herein after called the initiator, and credited to the user account of the remittee.

A data record is stored for each transaction on the data storage and assigned to the corresponding user accounts of the initiator and remittee, respectively. The term data record, as it is used hereinafter, is understood to refer to a set of data fields, which are related as regards to content. For instance, a data record can contain an execution date, an amount to be transferred, a remittee (or recipient) of the payment, and an initiator, in addition, the data record can contain the previous and current account balance of the user accounts to which it relates. Data records are stored preferably in the form of a database, particularly a relational database.

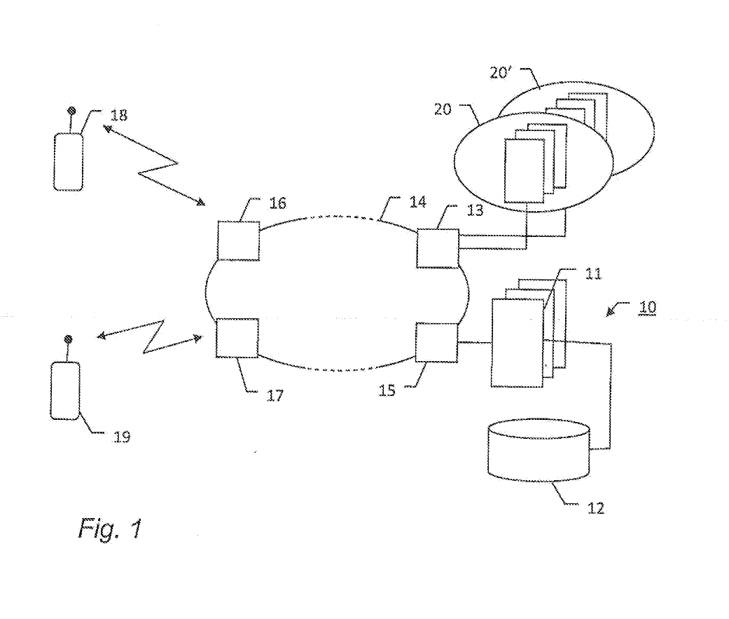

FIG. 1 shows the communication between user terminals 18, 19 and a server-based payment system 10. The payment system 10 contains a server platform 11 of the aforementioned type, and a data storage 12, which is connected to the server platform 11. The server platform 11 is connected through a data interface to an access node 15 of a telecommunications network 14. The telecommunications network 14 has further access points 16, 17, which provide wireless access for mobile user terminals 18, 19, such as smartphones or tablet PCs. The air interface between user terminals 18, 19 and access points 18, 17 can be any kind of mobile radio interfaces, including but not limited to HSDPA (High Speed Downlink Package Access), i.e. the data interface of the mobile radio standard UMTS (Universal Mobile Telecommunications System), the air interface of the mobile radio standard LTE (Long Term Evolution), or the GPRS (General Package Radio Service) interface of the mobile radio standard GSM, as well as a wireless Internet access, also know as WiFi.

Telecommunications network 15 is not necessarily a single homogeneous network, but can contain a plurality of interconnected sub-networks of different network layers and protocols, potentially operated by different network operators. Telecommunications networks of this kind are generally known to those skilled in the art and therefore do not need to be described here in more detail. In the context of the present invention, what has to be understood is that a data connection can be established through telecommunications network 14 between a user terminal 18, 19 and the server platform 11. Preferably, the data connection is a package switched connection established by means of a package protocols such as the Internet Protocol (IP).

In order to have access to payment system 10, a user terminal, such as user terminal 18, establishes a data connection to server platform 11 via communications network 15. For security reasons, the data connection is preferably established using encryption protocols such as TLS (Transport Layer Security), the predecessor version SSL (Secure Sockets Layer) or the IPsec (Internet Protocol Security) protocol.

Over the telecommunications network 14, other Internet services can also be accessed, including but not limited to web-based communications platforms, which are commonly referred to as social networks. Such communication platforms may include social network services like Facebook, Twitter, Google+, or tumblr, to name but a few. Such social network services are hosted by network servers. In order to exemplarily indicate this in FIG. 1, two server platforms 20, 20′ are connected via an access or gateway node 13 to telecommunications network 14. Server platforms 20, 20′ are deemed for the sake of the below description to host different social network services of the kind described before, e.g. the Facebook and the Twitter social network service.

In order to use or access internet services like social networks or the payment system in FIG. 1, a user typically has to authenticate with a server of the respective service provider first, by entering pre-assigned user credentials like user name and password. Sometimes, such user credentials are already stored on the user terminal and automatically transmitted to the service provider, so that the user does not have to manually re-enter his credentials each time he uses the service.

As it is well-known, in the art, social network services store contact lists of so-called “friends” or “followers” with whom a user has connected on the communication platform of the respective social network. According to an aspect of the present invention, the payment system 10 makes such contact lists available to a user for the selection of the recipient for an electronic money transfer. As will be seen below, payment system 10 communicates with a dedicated application program installed on user terminal 18, 19. Such application programs for mobile user terminals are commonly referred to as “apps”.

For the purpose of the below description, the payment service will be referred to as “cashcloud”, the payment system 10 as cashcloud backend or briefly as backend, and the application installed on the user terminal 18, 19 as cashcloud app or cashcloud frontend. Moreover, by way of not limiting example, reference is made in the below description to social network services Facebook and Twitter. It should be understood, however, that the present invention is not limited to particular social network services, but can be applied to any kind of communication platforms, which provide APIs (Application Programmers Interfaces) for external access.

The integration of friend lists from social networks like Facebook and Twitter allows the cashcloud user to send money to every friend without having a need to know his bank account details, like account number, bank code or IBAN and BIC. Fundamentally, the cashcloud user just selects a recipient by his or her friend name listed in the chosen social networks. After receiving this transaction information, the recipient can confirm or decline the transaction within his cashcloud mobile application on his smartphone or by using the internet browser connected to the website of cashcloud. The amount of money then moves from the cashcloud user “initiator” to the cashcloud user “recipient”.

As will also be seen in more detail below, the cashcloud backend 10 makes contact lists of social networks Facebook and Twitter available to the cashcloud app installed on user terminals 18, 19. The cashcloud backend must therefore access Facebook and Twitter servers 20, 20′ in the name of and with privileges allowed by the user. This is achieved through Facebook and Twitter APIs using so called access tokens.

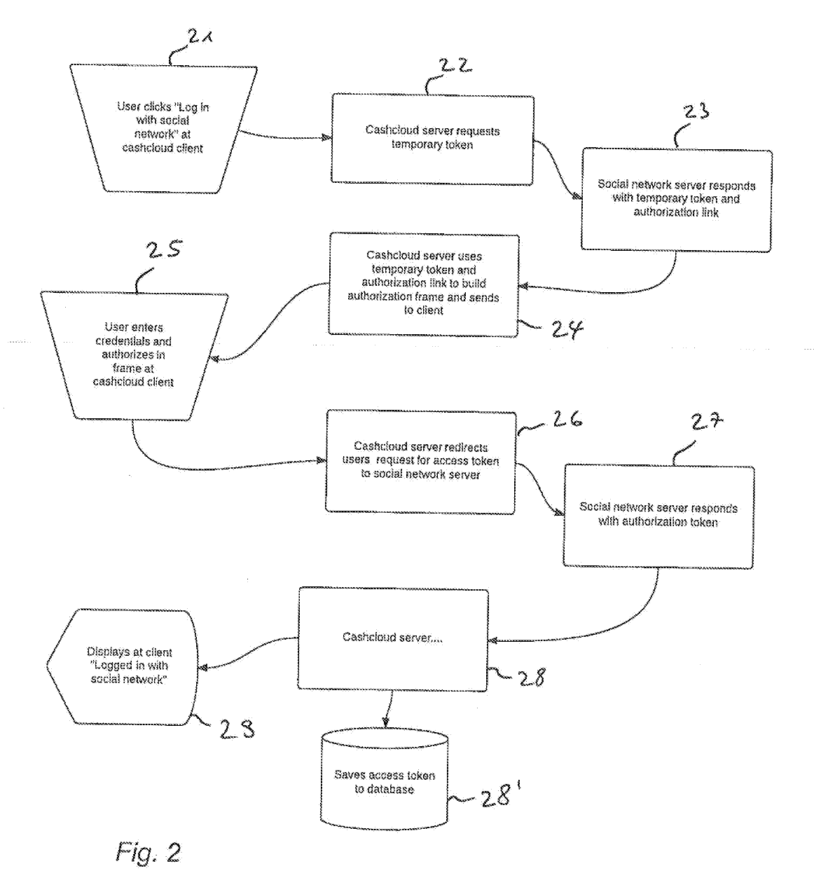

An access token is a protected object that contains information about an identity and privileges associated with a user account. Access tokens can be temporarily valid for a certain period of time, after which the token expires, or can be permanently valid. FIG. 2 shows in a workflow the steps and communication between cash cloud app, cashcloud backend, and a social network server to create an access token that can be used by the cashcloud backend to retrieve contact lists from the corresponding social network server.

In FIG. 2, the actions shown on the left-hand side relate to actions that occur at the cashcloud app, the actions in the center of FIG. 2 relate to actions of the cashcloud backend, and the actions on the right-hand side of FIG. 2 relate to interaction with a social network server.

In a first step 21, a user activates in the cashcloud app installed on his mobile user terminal a login function to enable login within a social network. The cashcloud app sends a corresponding request to the cashcloud server, as a reaction to which the cashcloud server requests in step 22 a temporary request token from the social network server. The temporarily request token is issued by the social network server only to enable the generation of an authorization request page for the user and to associate the corresponding return message sent back by the user with the initial request by the cashcloud server, in order to identify and correlate which external service the user has authorized to act on his (or her) behalf. The request token expires as soon as the user response arrives at the social network server.

In step 24 the cashcloud server receives the temporary request token and an authorization link from the social network server and uses these to build an authorization frame and send if to the user terminal. At the user terminal, a login screen is shown to the user, where the user enters his credentials and acknowledges the privileges that will be granted to the cashcloud server within a frame embedded in the cashcloud app. A login function implemented in the embedded frame creates from the user credentials and the temporary request token a request for an access token and sends the request to the cashcloud server, in step 28 the cashcloud server redirects the user request for an access token to the social network server. In step 2, the social network server verifies the user credentials and the temporary access token and responds with sending an access token to the cashcloud server. The cashcloud server in step 28 saves the access token in a database 28′ and forwards the access token to the Facebook app running on the user terminal. In step 29, the face book app displays at the user terminal a message telling the user that the login with the social network was successful.

The access token is issued by the social network server and represents the authorization granted by the user to the cashcloud server to collect specific data from a social network account and to act on his behalf. By redirecting the user to the server of a social network for login, it will be achieved that authentication occurs under the sole responsibility of the social network server, while the cashcloud server has no need to know and no possibility access the user's credentials, which serves for security, data privacy, and testability reasons.

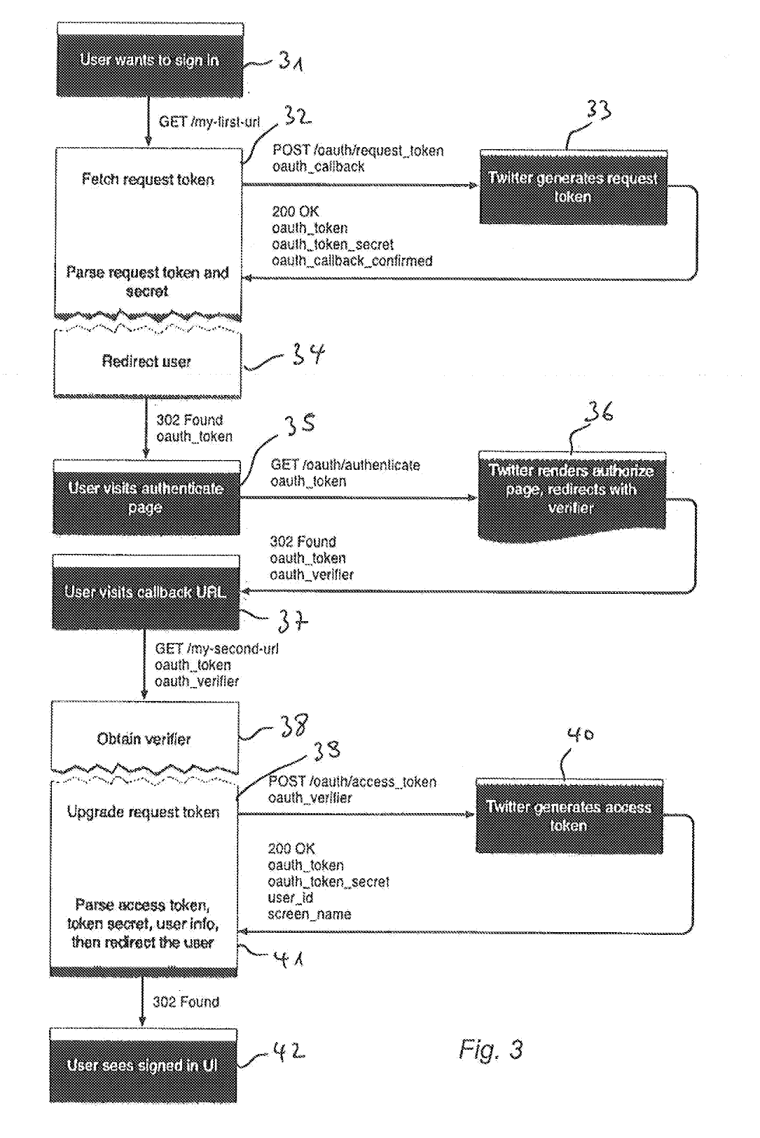

FIG. 3 shows as an example the login procedure of the social network Twitter. This login procedure is used to grant to the cashcloud server authorization to collect data on behalf of a user from the Twitter network. The communication between the cashcloud server and the Twitter server is performed by using a Twitter provided API over HTTPS (Hypertext Transfer Protocol Secure) protocol. The authentication makes use of the OAuth protocol, an open standard for authorization, i.e. a method for clients to access server resources on behalf of a resource owner. Request and response parameters are illustrated in FIG. 3.

When in step 31 a user wants to sign in from the cashcloud app running on his mobile terminal and hits, for instance, a button labeled “Sign in with Twitter”, the mobile terminal sends a request message GET/<1^{st} social network URL> to the cashcloud server to call and display to the user the Twitter login page. In process 32 the cashcloud server has to request a temporary request token from the Twitter server in order to be able to build the link for the Twitter login page to which the user will be directed to authenticate and authorize access and actions on his behalf by the cashcloud system. The cashcloud server provides in the request a callback URL, where it can catch the verifier in a later step. The Twitter server responds in step 33 with a request token, token secret and a confirmation. The cashcloud backend then builds in step 34 a link to the authorization page and directs user to this link.

In step 35, the user has to provide at the authorization page, which is rendered by the Twitter server, his user credentials and authorize, if he is not already logged in to Twitter, or just authorize the application's actions, if he is already logged in. The Twitter server redirects the user in step 36 to the callback URL and passes a verifier (oauth_verifier), too. The verifier has a PIN-like function: If correctly resent with the request token, it will allow the application to exchange the request token for a valid access token and token secret pair. When the user then visits in step 37 the callback URL (“GET/<2^{nd} social network URL>”), the received request token (“oauth_token”) and verifier will be included in the GET request.

The cashcloud server parses in step 38 the received response to find the verifier and sends in step 39 a request with the verifier and the request token to the Twitter server, asking to obtain an access token and token secret pair that can be used to act on behalf of the user.

The Twitter server checks in step 40 if the request token is accompanied by the right verifier and if so, provides a valid access token and token secret pair back to the cashcloud server. The response of the Twitter server also contains a user_id, i.e. the user's internal ID at Twitter, and a screen_name, which stands for the user name at Twitter. Response values are stored in the backend's database for later use and the user is redirected in step 41 to a Twitter page on which he sees in step 42 a user interface (UI) that tells him about the successful login attempt.

This or a similar process can be used for any social network enabled and connected to the cashcloud mobile application. The access token created through the above descripted procedure can now be used by the cashcloud server to retrieve on behalf of the user a contact list from the user account at the corresponding social network. An access token generated by the Twitter server, for instance, is a permanent token, which does not expire, while an access token generated by the Facebook server will be a temporary token, which expires after one hour. After the token has expired, Facebook login has to be performed again and the token is then renewed.

Once the cashcloud server has collected a contact list from a social network, it parses the contact list and identifies contacts that are already registered users of the cashcloud service. In order to inform the user to which of his contacts he can send money through the cashcloud service, the cashcloud server marks contacts in the list, which are already registered to cashcloud, accordingly.

The cashcloud application allows a user to select a recipient for an electronic money transfer either from the local address book or from contact lists of those social networks that have been enabled by the user. In order to consolidate the local address book with the contact lists from any social networks, the cashcloud application retrieves the local contact list from the local address book stored on the user terminal and sends the local contact list to the cashcloud server. For instance, the local contact list can be sent to backend in the body of an HTML POST request. The cashcloud server retrieves on behalf of the user contact lists from any enabled social network using the corresponding access tokens to authorize with the respective social network server.

The cashcloud server than merges and sorts the contact lists and checks for each of the contacts, if it already exists in the cashcloud database. Contacts that are registered cashcloud users are marked accordingly. The cashcloud server then returns the processed contact list. For data privacy reasons, the contact lists will not be stored at the cashcloud backend, but are only processed by the backend and then returned to the user terminal, where the processed list is then stored.

An example of the message exchange between the application on the user terminal and the cashcloud server is shown below:

```
{
  “entries”: [
    {
      “source”: “email”,
      “value”: “test@mail.com”
    },
    {
      “source”: “email”,
      “value: “test2@mail.com”
    },
    {
      “source”: “email”,
      “value”: [“test3@mail.com”, “test4@mail.com”]
    }
  ],
  “user_facebook”: {
    “access_token”: “AAAF6sd6O0hQBAK5bRZAOTfe0bp8o7EAphqScuyJp”
  },
  “user_twitter”: {
    “access_token”: “AAAF6sd6O0hQBAK5bRZAOTfe0bp8o7EAphqScuyJp”,
    “access_token_secret”: “AAAF6sd6O0hQBAK5bRZAOTfe0bp8o7EAphqScuyJp”,
  }
}
```

The cashcloud application sends in the body of an HTML POST Request the list of contacts from the local address book to the cashcloud server. The list contains for each entry a source and a value parameter. The source parameter determines the origin of the contact, which in the example is “email” for the user's local e-mail address book. The corresponding value parameter indicates the respective e-mail address. Multiple e-mail addresses for the same contact are possible. Optionally, first name and last name parameters can be indicated for each entry in addition to source and value parameters. Moreover, the request message contains for the social networks that have been enabled by the user corresponding access tokens, which give the cashcloud server authorization to retrieve contact lists from the corresponding social network servers on behalf of the user.

It will be understood that the indication of access tokens in the request message is optional since, as explained above, the cashcloud server may already have stored corresponding access tokens. However, in an alternative implementation, as will be seen farther below, access tokens can also be requested by the user terminal and generated by the social network server without involvement of the cashcloud server. Thus, explicit inclusion of access tokens into the request message makes sure that the cashcloud server always has a valid and not expired access token to retrieve a contact list from the corresponding social network.

The cashcloud server checks for each of the contacts, if it already exists in the cashcloud database. For all social networks, for which the user has allowed access to his data, the cashcloud server makes updates to the contact list and sorts the contact list alphabetically by last name. The processed contact list is then sent back to the cashcloud application running on the user terminal. An example of such response message is given below:

```
{
  “error” : false,
  “entries”: [
    {
        “email”: “test@mail.com”,
        “facebook_id”: “if user have facebook_id”,
        “username” : “bla-bla-bla”,
      “first_name”: “first_name”,
      “last_name”: “last_name”,
      “newUser” : false,
    },
    {
        “facebook_id”: “facebook_id”,
        “username” : “bla-bla-bla”,
        “newuser” : true
    },
    {
        “email”: “test2@mail.com”,
        “newUser” : true
    }
  ]
}
```

Apart from the fact that the returned list is a consolidated list assembled from the local contacts and the social network contacts, the parameter “newUser” indicates whether the respective contact is already a registered cashcloud user (i.e. false) or whether he would be a new user to the cashcloud service (i.e. true). Moreover, if for a particular entry a Facebook or Twitter ID is known, this information will be included as well, in order to enable the cashcloud app to pre-create a connection between any cashcloud user account and corresponding Facebook or Twitter accounts. If such connection exists, the cashcloud app will visualize this to the user by showing a corresponding icon next to the contact entry in a selection menu.

This processed contact list is now used by the cashcloud application to generate the selection menu, from which the user can select a recipient for electronic money transfer. Entries in this selection menu for contacts who are already cashcloud users are marked graphically so that the user will know to whom of his friends he can directly transfer money.

It is also possible for the user to select as a recipient a contact who is not yet registered as cashcloud user. However, in this case, the cashcloud backend will inform the recipient through the social network communication system on behalf of the user or by a direct e-mail about the planned transaction. This message invites the recipient to register with cashcloud in order to be able to receive the payment. The message sent to such unregistered recipient will contain an identifier and an URL (uniform resource locator) leading to a registration page that has the identifier in URL parameters. When the recipient of this invitation clicks on the link, he will be automatically directed to a registration application page, where he can fill in a corresponding registration form to register with cashcloud.

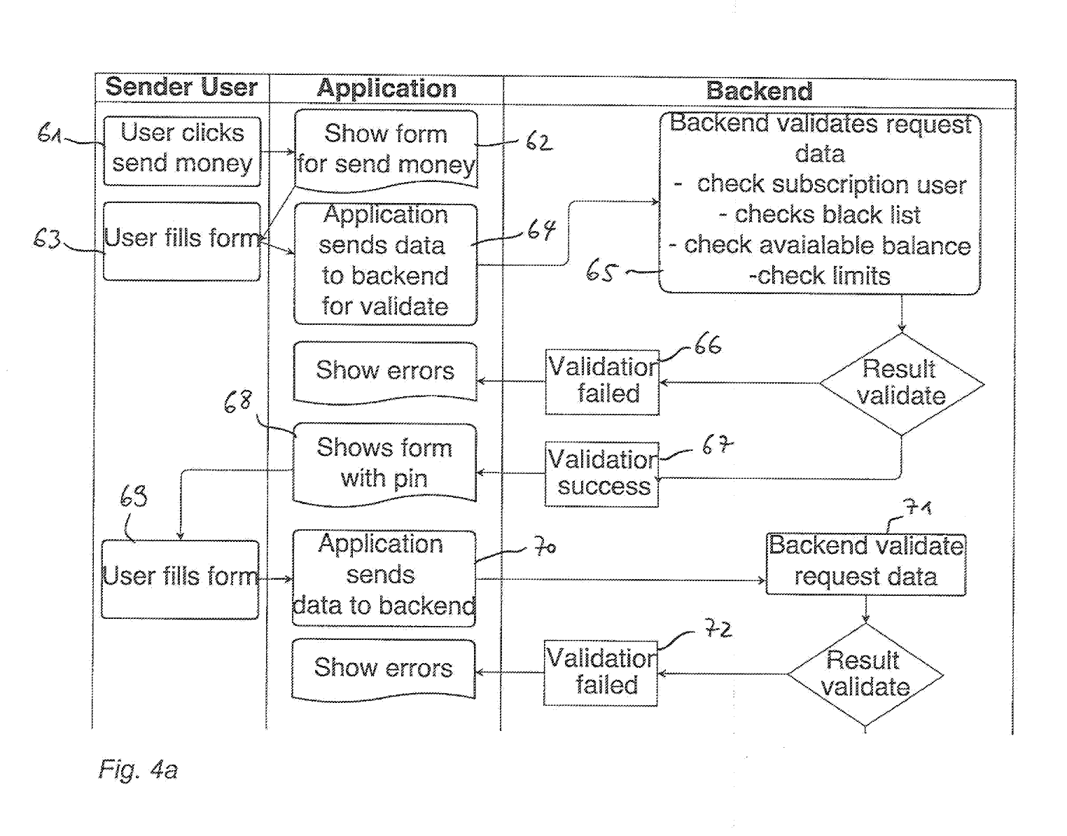

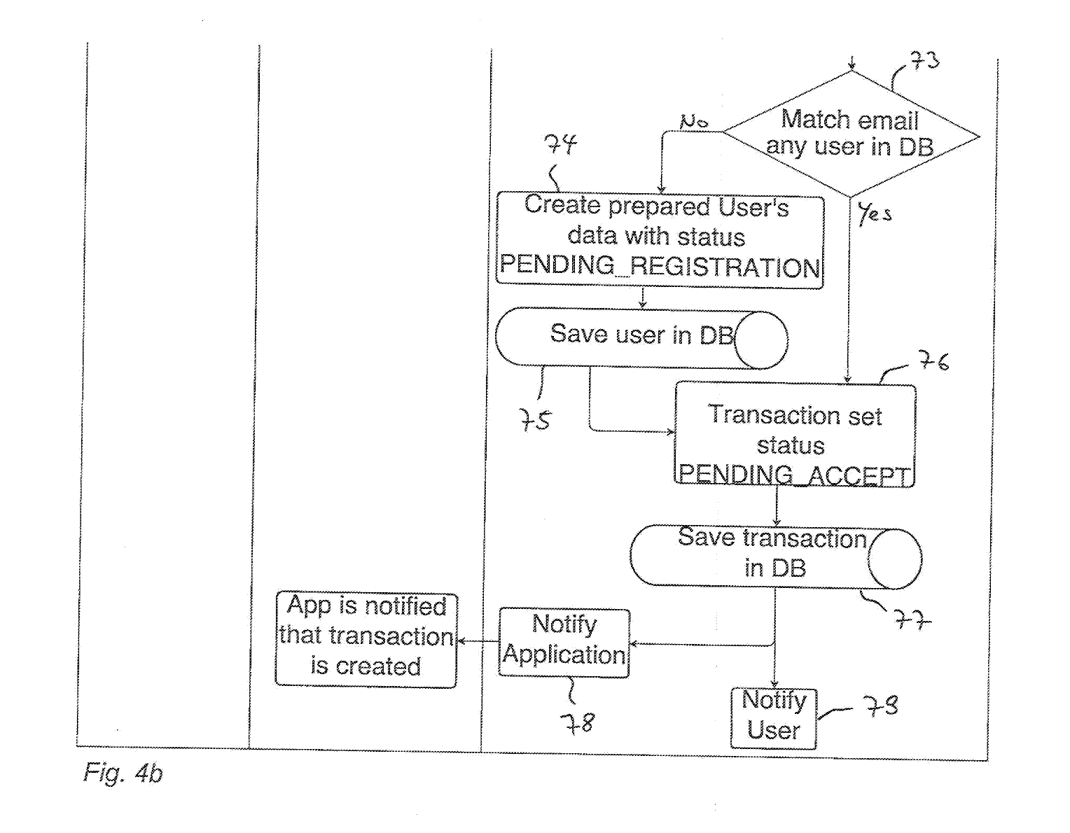

The process of creating a transaction in the cashcloud system is shown as a flowchart in FIGS. 4a and 4b. In this flowchart, the left-hand column contains user interactions, the middle column shows steps performed by the application installed in the user terminal and the right-hand column shows steps which take place at the cashcloud server.

The application has a main menu which contains a button for a send money function. If in a step 61 the user clicks on this “send money” button, the application shows in step 62 a form for the send money function. In step 63 the user has to fill in the form to indicate a recipient and an amount to be transferred and a reason for the transaction.

In step 64, the application sends the entered data to the cashcloud server for validation. A corresponding request message, sent in the body of a HTML POST request, is shown below;

```
{
  “credit_user”: {
    “source”: “email”,
    “value”: “user@mail.com”
  },
  “amount”: 10,
  “reason_id”: 69
}
```

The request message contains the entries “credit_user”, “amount”, and “reason_id”. The entry “credit_user” contains the parameter “source”, which indicates the channel who which the recipient can be informed about the money transaction, e.g. e-mail, Facebook, or Twitter, and a parameter “value” which identifies the recipient by either his e-mail address, Facebook name, or Twitter ID, depending on the value of “source”. The entry “amount” contains the amount to be transferred in Euro cents. The entry “reason_id” contains an identifier of a reason selected from a predefined list.

In step 65, the cashcloud server checks the subscription level of the originator, whether he has an available balance on his user account, and whether optional daily, weekly, or monthly transfer limits, based on the subscription level, have not been exceeded, already. A further check can be made on whether the originator or the recipient are blacklisted. If the validation fails, the cashcloud server will send in step 66 a corresponding error message to the cashcloud application, which will be shown on the screen of the user's terminal. For instance, if the e-mail address or contact details of the recipient are invalid or missing, the application will show a specific warning, if the entered amount exceeds the available balance, the application will also show a specific warning.

If the validation is successful, the server will send in step 67 a corresponding response message back to the application. The response can also contain a fee calculated in dependence of the user's subscription and fee model. An example of a response message is given below:

```
{
  “error” : false,
  “amount” : transaction amount,
  “fee” : transaction fee,
}
```

When the application receives the response message indicating that the amount and recipient details fulfill the formal requirements, a send money screen will be displayed to the user in step 68, showing to him again the details of the transaction and requesting entry of a password or PIN for the cashcloud service. The user can then, in step 69, either cancel or confirm the transaction by entering his password or PIN. After the user has entered his password or PIN and presses a confirm button, the application will send the below request back to the cashcloud server to validate the entered password or PIN.

```
{
  “credit_user”: {
    “source”: “email”,
    “value”: “user@mail.com”
  },
  “amount”: 10,
  “reason_id”: 69,
  “remark”: “test”,
  “pin”: “NjczNTUwMTdbMzk3WMxOOR1ZGUzZmQ5ZmVkZTI3ZDY=”,
  “user_facebook”: {
      “access_token”: “AAAF6sd6O0hQBAK5bRZAOTfe0bp8o7EAphqScuyJp”
  },
  “user_twitter”: {
      “access_token”: “AAAF6sd6O0hQBAK5bRZAOTfe0bp8o7EAphqScuyJp”,
      “access_token_secret”; “AAAF6sd6O0hQBAK5bRZAOTfe0bp8o7EAphqScuyJp”
  }
}
```

The parameter PIN represents a double hash value generated according to the following formula:

$hash=md5(sha1($userEmail.$pinSalt.md5(sha1($pin, true), true), true)); $pinHash=base64_encode($hash)

In this formula, $userEmail denotes the email address of the user, which is used as user name in cashcloud, $pin is the PIN code entered by the user. The parameter $pinSalt is a random parameter, which consists of 32 random symbols out of the following group:
“ABCDEFZHIKLMNOPQRSTVXabcdefzhiklmnopqrstvx1234567890”

The hash value $hash is finally coded with the function base64_encode( ) in order to convert the 8 bit binary value into a code page independent ASCII sequence $pinHash.

The server will check in step 71 the entered PIN or password to validate the request. If the entered PIN or password was incorrect, a validation failed message is sent in step 72 to the application, which will display a corresponding error message on the screen of the user terminal. Otherwise, if the validation was successful, the process continues on FIG. 4b.

As a next step, the cashcloud server will check whether the recipient is already a registered cashcloud user, e.g. whether the indicated e-mail address matches any user in the cashcloud database. If the user is not (yet) registered with the cashcloud system, a new user data record will be created for him in step 74, which will have the status “pending registration”. The new user data record is stored in the cashcloud database in step 75, and the workflow proceeds to step 76. If the user already existed in the cashcloud database, the workflow directly proceeds to step 73, where a transaction is created and set to status “pending accept”.

In step 77 the transaction is stored in a form of a data record in the cashcloud database. In addition to the status indication, the data record includes at least the amount to be paid, the cashcloud user who sends the electronic payment (i.e. the initiator), and the recipient or remittee of the payment.

In step 78, a response is sent back to the cashcloud app in order to notify that the transaction has been created. The response has the format as shown below. It contains the HTTP status code 200 which indicates successful creation of the transaction:

```
{
  “error”; false,
  “code: 200
}
```

Finally, in a step 78, a notification is sent to the recipient. This notification is sent either as an e-mail to the recipient directly or, if the recipient was selected from a social network contact list, via his in box at the respective social network. In order to avoid problems with spam filtering at the social network server, a message to the recipient through the social network platform can alternatively be sent in the name and on behalf of the initiator. This might require the user to enter his user credentials of his social network account again in order to authorize the cashcloud backend to act on his behalf.

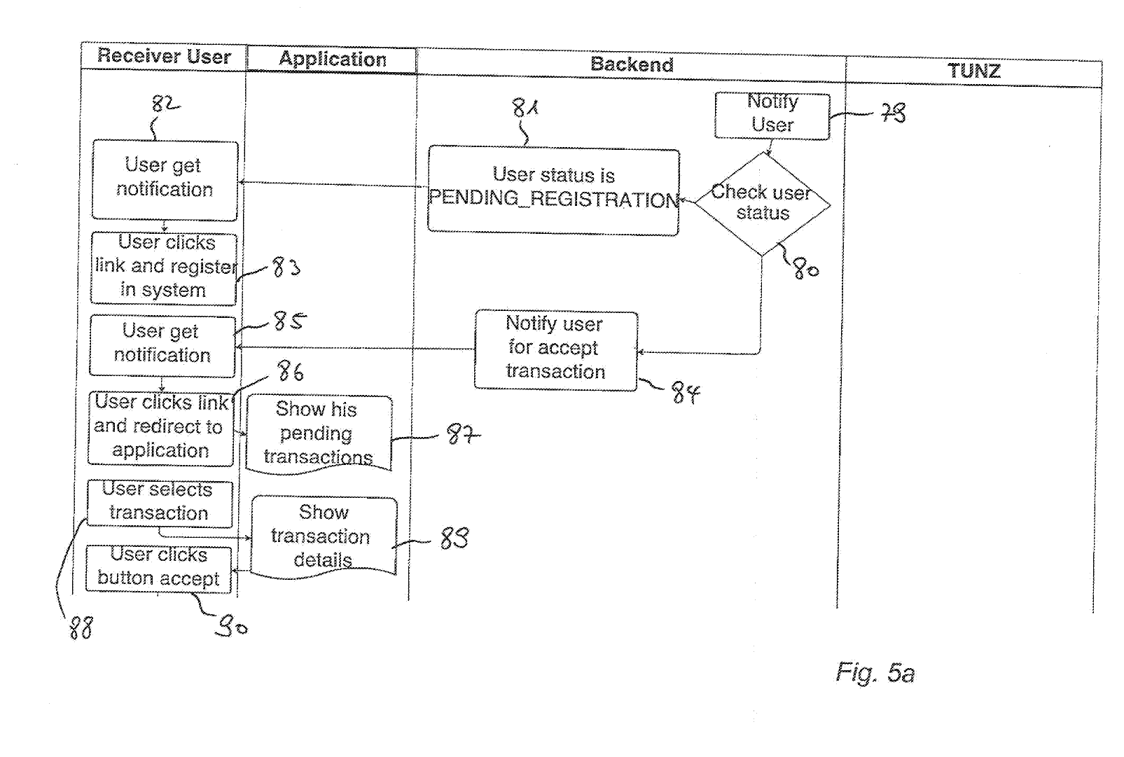

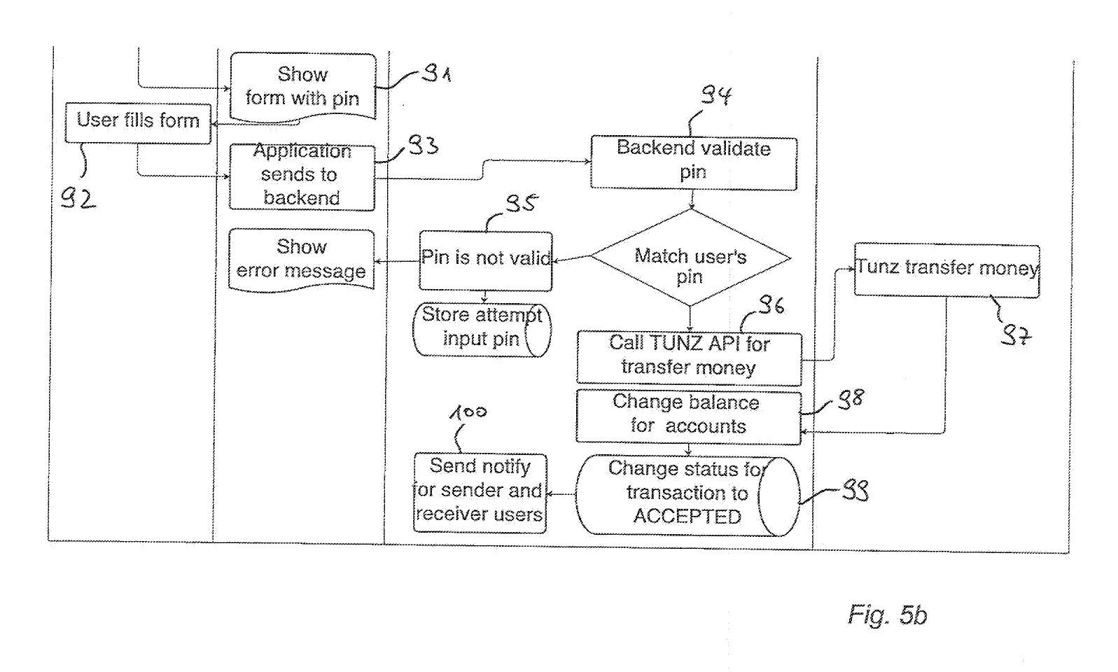

After a transaction has been successfully created and the recipient been notified in step 79, the process of executing the transaction as shown in the workflow of FIGS. 5a, 5b is started. In FIGS. 5a, 5b the first column denotes user interactions by the recipient, the second column relates to actions performed by the cashcloud application running on a terminal of the recipient, the third column relates to actions performed at the cashcloud server, and the fourth column relates to interaction with a licensed e-money issuer, such as TUNZ.

In step 80, the status of the data record in the cashcloud database relating to the recipient is checked. If the corresponding user data record has the status “pending registration”, meaning that the recipient is not a registered cashcloud user, the cashcloud system will notify him with an e-mail, either directly or through the inbox of a social network, about the pending transaction. As mentioned before, the e-mail will contain an identifier and an URL link leading to a registration page, where the user can register in order to receive the electronic payment. In step 82 the user will receive the invitation message and he can then, by following the enclosed link, visit the registration page and register in step 83 as a new cashcloud user.

If the status check in step 80 reveals that the recipient is already a registered cashcloud user, or if the recipient has successfully registered as a new cashcloud user, a notification is sent in step 84 requesting the recipient to accept the transaction. In step 85 the user receives a notification about the pending transaction, and he can then in step 86 follow a link included in the notification, which will redirect him to the cashcloud application, either in the form of a web portal, or the cashcloud app running on this mobile terminal. In step 87 the cashcloud application will show him a screen with all pending transactions assigned to his user account.

In step 88 the user can select a transaction from the selection shown to him by the application, and he will then be shown in step 89 details of the selected transaction. In step 90 the user can hit an accept button shown to him for the selected transaction. When he hits the accept button, the workflow proceeds in FIG. 5b.

The application will now, in step 91, request the user to enter his user credentials, e.g. his user PIN. In step 92 the user has to enter his PIN and the application will send in step 93 a request with the hash encoded PIN to the cashcloud server. In step 94, the cashcloud server validates the PIN. If the PIN is invalid, a corresponding error message is sent back to the application in step 95 and shown to the user. In addition, the number of invalid attempts for entering the PIN can also he stored in the cashcloud system in order to lock the user account after a predefined number of invalid attempts.

If the PIN is validated successfully, the cashcloud server initiates in step 96 the actual money transfer. This occurs in the embodiment through a licensed e-money issuer, in this case the company TUNZ, by calling a money transfer function available in the API of the e-money issuer. In step 97, the actual money transfer takes place at the e-money issuer, and a confirmation is sent back to the cashcloud server. In step 98, the cashcloud server changes the balance for the accounts of the initiator and recipient stored in the cashcloud database. In step 99, the status of the transaction is changed to “accepted”. Finally in step 100, a notification about the successful money transfer is sent to both the initiator and the remittee of the transfer.

FIG. 6 shows the menu structure and graphical user interface of the cashcloud app, which is installed and running on a mobile user terminal. Screen view A shows the main menu with which the cashcloud application starts after successful authentication. Main menu A has several push buttons for various functions such as checking the account balance, topping up the account from a credit card, checking open transactions, and others. Button 102 serves to send money to other cashcloud users. When button 102 is pushed, send money screen B will open. With back button 104 the user can go back to the previous screen. To initiate an electronic payment, the user has to fill in the required fields. In field 108 the user can either manually enter an e-mail address of a recipient, or he can choose a recipient from a selection list, in field 108 he needs to enter an amount to be transferred. In field 110 he can select a reason for the payment from a drop-down menu. In field 112 he can enter a comment, if desired. At the top of menu B the cashcloud user will see his available balance. The amount that can be transferred cannot be higher than this available balance.

In order to select the recipient from a selection list, the user can press the friend icon 114 and the application will move to screen C, which shows a menu of contacts taken from the local address book and from one or more social networks that have been enabled by the user to be used for cashcloud services. Those contacts in the selection list, which are already registered as cashcloud users themselves, are marked with an icon 118. The cashcloud user will thus know which of his friends and contacts can already receive electronic payments through the cashcloud electronic payment service. In addition, a Facebook or Twitter symbol shows if the contacts are also included in or taken from the Facebook or Twitter contact lists. When the user selects an entry from the selection list of contacts on screen C, the information will be transferred to the send money screen B and prefilled in the address field 108.

Back to screen B, the user can choose an amount he wants to send by navigating to the amount field 108. This will automatically open amount screen D, which shows a numeric pad to enter the amount. By pushing the button “Done”, the entered amount will be transferred into the amount field 108 of screen B.

Back on screen 6, the user can enter a reason for the payment by navigating to field 110. This will open screen E with a selection list of predefined reasons, where the user can select an entry that will be transferred to field 110. If the user does not want to choose any of the pre-offered reasons from the list, field 110 can be left blank or the user can select an entry “Other”.

In field 112, the user can enter a free text message as comment, which will be transferred together with the transaction to the recipient. After the form on screen B has been filled in, the user can push the “send money” button 113 and the cashcloud application will send the data for validation to the cashcloud server as described above. Upon successful validation of the entries through the cashcloud server, the cashcloud app will move to screen F, where the user is requested to enter his PIN in field 122 to confirm and authorize the transaction.

On screen F, the application will show the selected payment amount and the fee for the electronic money transfer calculated by the cashcloud server. The cancel button 118 will move the user back to screen B. When the user navigates to field 122, the keyboard appears for the entering of his PIN. When entering the PIN, the application will only display hidden characters. When the PIN is entered, the user has to confirm with button 124 and the application will send a request with the hash-encrypted PIN code to the cashcloud server for validation, as described above.

If the creation of the transaction at the cashcloud server was successful and confirmed, screen G is shown to the user informing him of the successful creation. The button “Done” will move the user to a screen H, where he can optionally share his experience about the cashcloud service on any social networks that he has activated for cashcloud services.

As an alternative to allowing the cashcloud backend to retrieve contact lists from social network accounts of the user, the cashcloud frontend can connect to individual social networks directly and then load contact list from the corresponding social network user account.

The cashcloud app thus provides a screen view I, where the user can select a social network such as Facebook or Twitter. If the user selects one of these, he will be asked to enter his user credentials for the respective social network. Upon successful login with the social network, the cashcloud app will directly retrieve the contact list of the social network user account and display the list in a screen view K for Twitter or J for Facebook friends. A selection from any of these lists J, K will be transferred into send money screen B and pre-filled into field 106 as recipient of a transaction.

As an example: The cashcloud user may want to select a friend from Facebook, like in Facebook screen J. If the cashcloud user has not already enabled and connected to the social network of Facebook, the application displays Facebook “Log in” social graph application of Facebook in the form of an embedded web page frame, where the cashcloud user has to enter his email and password to connect with Facebook. Then he can confirm the access to his Facebook data by the cashcloud application and all Facebook friends will be shown on screen J. The application sends data about the friends from the Facebook profile to the backend and saves if in database in order to pre-create a connection between the cashcloud user account and this Facebook ID.

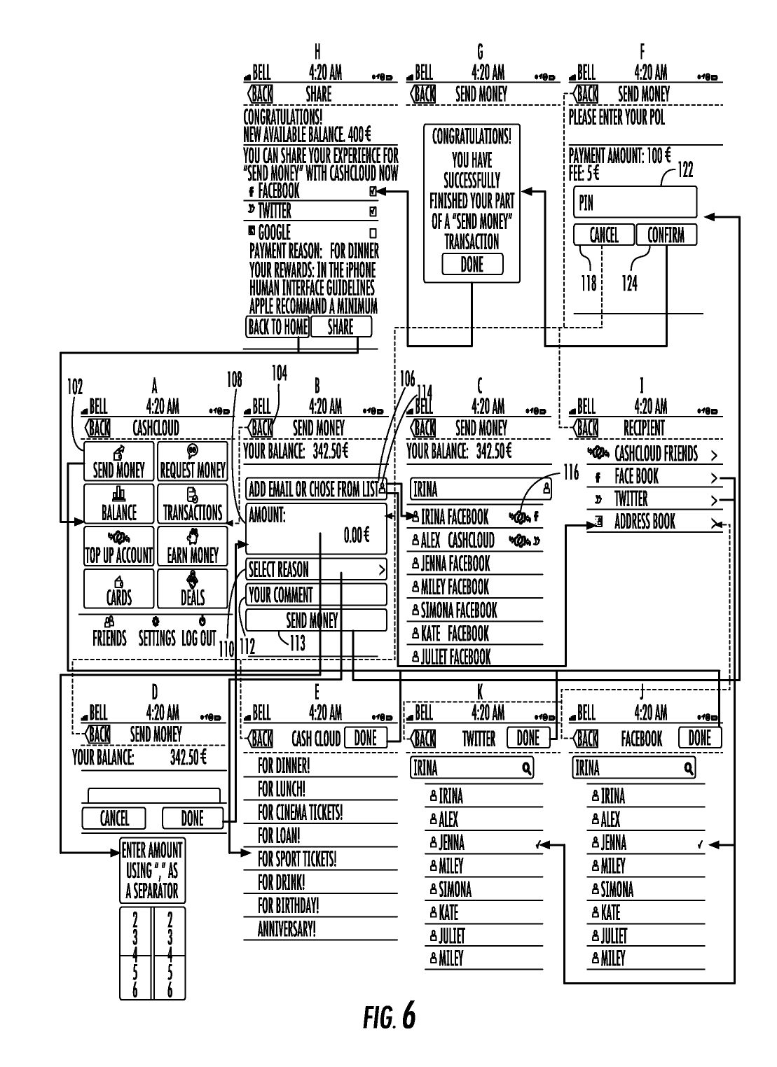

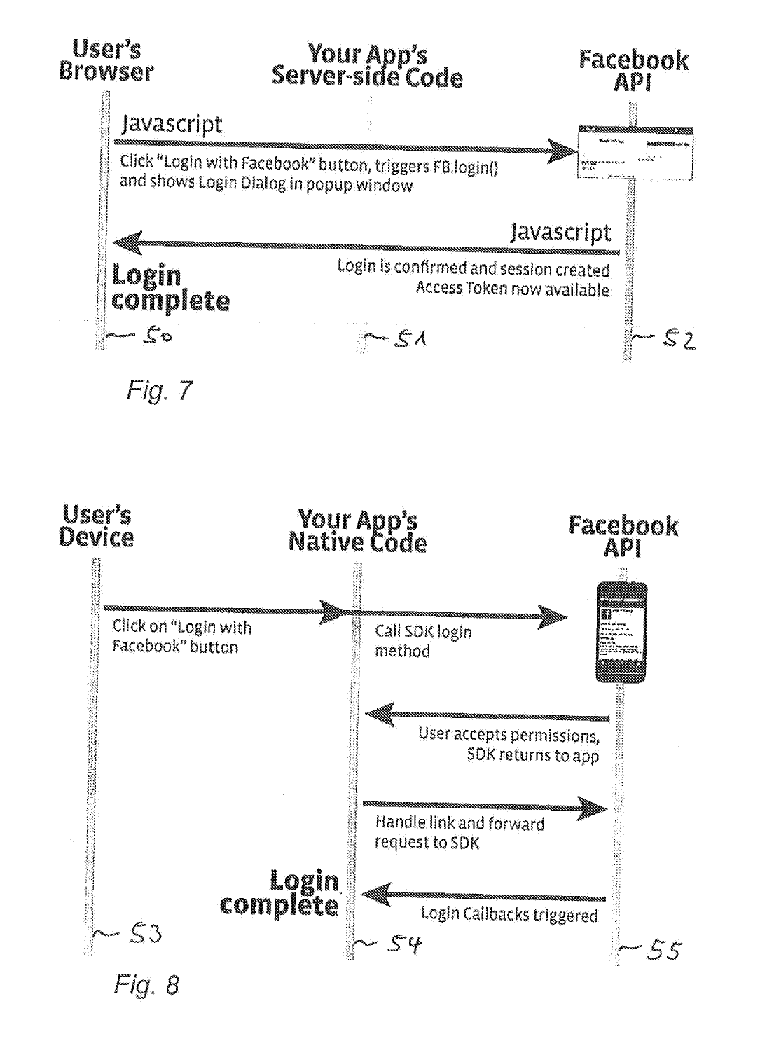

FIGS. 7 and 8 show two alternative login methods that can be used to login with Facebook. The login method shown in FIG. 7 is used in an implementation of the cashcloud service as a web portal. The user accesses with his web browser 50 a web portal 51 at the cashcloud web server and displays a corresponding web page of the portal in his browser 50. The web page contains a face book login button, which upon activation triggers a JavaScript login function FB.login( ) of the Facebook API 52. The JavaScript function FB.login( ) displays a login dialog in a popup window, where the user enters his credentials. The Facebook API 52 uses the OAuth2.0 authorization framework implemented in JavaScript to confirm login and successful creation of a session and returns an access token. The web portal 51 shows on the user's browser a login complete message.

The second login method, which is shown schematically in FIG. 8, is used by a mobile user terminal 53, which has a cashcloud app installed, rather than accessing a remote web portal from a user terminal with a conventional web browser. The cashcloud app 54 shows to the user a button for the login with Facebook similar to screen view I of FIG. 6. When this login button is pressed by a user, the app 54 calls the SDK (Software Development Kit) login method available in the Facebook API. In particular, the app 54 sends to the Facebook server 55 a request for authorization, which includes a unique application ID that identifies the application at the Facebook server. The request for authorization also includes a callback URL to which the Facebook server 55 shall redirect the reply.

Under the callback URL, the Facebook server 55 provides in the form of an embedded web page frame a login screen, which is part of the Facebook SDK, where the user—if not already logged in with Facebook—has to enter his user credentials and then confirm the access rights granted to the cashcloud app to access his Facebook data. The Facebook SDK then returns to the application 54 with a validation code and a callback URL.

The application 54 can then call the Facebook SDK at the Facebook server 55 again under the callback URL and authorizes with its unique application ID and the validation code provided in the previous step by the Facebook SDK. The Facebook server confirms the successful login and returns an access token that the cashcloud app can use to access the friend list on the Facebook account of the user.

The cashcloud user can select a friend from other social networks as well. For Twitter for instance, the application displays Twitter “Log in” social graph application of the Twitter API as an embedded web page frame, where the cashcloud user has to enter his email and password to connect with Twitter. He can then confirm the access to his Twitter data by the cashcloud application and all Twitter friends (which are typically called “followers” at Twitter) will be shown to him on screen view K of FIG. 6. The application sends data about friends of the Twitter profile to the cashcloud backend and saves it in a database in order to pre-create a connection between the cashcloud user account and this Twitter ID.

The description and drawings merely illustrate the principles of the invention. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods.

What is claimed is:

1. A method of creating a transaction at a server-based payment system, which is adapted to administrate a plurality of payment service user accounts; the method comprising:
generating an access token containing information about an identity and privileges associated with a social network user account pre-existing at a web-based communication platform;
transmitting said access token to said server-based payment system;
retrieving by said server-based payment system a contact list stored at said web-based communication platform for said social network user account using said access token as an authorization;
processing said contact list to determine whether corresponding payment service user accounts at said server-based payment system exist for entries of said contact list;
transmitting from said server-based payment system to a user terminal a processed contact list containing for entries, for which corresponding payment service user accounts exist, information indicative thereof;
at said user terminal, generating a payment order by selecting an entry from the processed contact list and indicating an amount to be paid;
transmitting said payment order to said server-based payment system; and
at said server-based payment system, creating a transaction and storing the transaction in a database of the server-based payment system, the transaction including, in the form of a data record, the amount to be paid, a initiator of the transaction, and a remittee of the transaction, as indicated by said payment order.

2. A method according to claim 1, wherein said step of generating an access token comprises redirecting a connection from said user terminal to an authorization link of said web-based communication platform; transmitting user credentials from said user terminal to said authorization link; and generating said access token at said web-based communication platform.

3. A method according to claim 1, comprising receiving at said server-based payment system from said user terminal a local contact list; consolidating said contact list retrieved from said web-based communication platform and said local contact list; and returning to said user terminal said processed contact list containing consolidated entries from said retrieved contact list and said local contact list.

4. A method according to claim to claim 1, comprising retrieving contact lists from two or more different web-based communication platforms using different access tokens generated at the corresponding communication platforms; consolidating said two or more contact lists; and returning to said user terminal said processed contact list containing consolidated entries from said two or more retrieved contact lists.

5. A method according to claim 1, comprising if no payment service user account for said remittee exists at said server-based payment system so far, creating a temporary user account entry for said remittee, assigning to said temporary user entry a pending registration status, transmitting an invite message to said remittee using a contact information contained in said payment order, said invite message containing a unique registration identifier and a link to a registration page; and upon registration of said remittee at said registration link, validating said temporary user entry by creating a new payment service user account for the remittee and assigning the transaction to said new payment service user account.

6. A method according to claim 1, comprising if a payment service user account for said remittee exists at said server-based payment system, assigning to said transaction a pending acceptance status and transmitting a notify message to said remittee, said notify message containing information about the pending transaction.

7. A method according to claim 6, wherein after said remittee connects to said server-based payment system to accept the pending transaction, said transaction is executed, account balances of the initiator's and the remittee's accounts are changed accordingly, and an accepted status is assigned to said transaction.

8. A server-based payment system comprising at least one host computer, an executable server application for administrating a plurality of payment service user accounts, and a data storage for storing user account data in the form of data records; wherein the server application is programmed to perform, when run on the at least one host computer, the following actions:
upon receipt of an access token containing information about an identity and privileges associated with a social network user account existing at a web-based communication platform, retrieving a contact list stored at said web-based communication platform for said social network user account using said access token;
processing said contact list, to determine whether corresponding payment service user accounts exist at said server-based payment system for entries of said contact list;
transmitting to a user terminal a processed contact list containing for entries, for which a corresponding payment service user account exists, information indicative thereof; and
upon receipt of a payment order generated at said user terminal by selecting an entry from the processed contact list and indicating an amount to be paid, creating a transaction and storing the transaction on said data storage, the transaction including in the form of a data record the amount to be paid, a initiator of the transaction, and a remittee of the transaction, as indicated by said payment order.

9. A server-based payment system according to claim 8, wherein said server application is programmed to initiate generation of said access token by redirecting a connection from, said user terminal to an authorization link of said web-based communication platform.

10. A server-based payment system according to claim 8, wherein said server application is programmed to receive from said user terminal a local contact list; to consolidate said contact list retrieved from said web-based communication platform and said local contact list; and to return to said user terminal said processed contact list containing consolidated entries from said retrieved contact list and said local contact list.

11. A server-based payment system according to claim 8, wherein said server application is programmed to retrieve contact lists from two or more different web-based communication platforms using different access tokens generated at the corresponding communication platforms; to consolidate said two or more contact lists; and to return to said user terminal said processed contact list containing consolidated entries from said two or more retrieved contact lists.

12. A server-based payment system according to claim 8, wherein said server application is programmed to, in the case that no payment service user account for said remittee exists at said server-based payment system so far, to create a temporary user account entry for said remittee, to assign to said temporary user entry a pending registration status, to transmit an invite message to said remittee using a contact information contained in said payment order, said invite message containing a unique registration identifier and a link to a registration page; and upon registration of said remittee at said registration link, to validate said temporary user entry by creating a new payment service user account for the remittee and assigning the transaction to said new payment service user account.

13. A server-based payment system according to claim 8, wherein said server application is programmed to, in the case that a payment service user account for said remittee already exists at said server-based payment system, assign to said transaction a pending acceptance status and transmit a notify message to said remittee, said notify message containing information about the pending transaction.

14. A server-based payment system according to claim 13, wherein said server application is programmed to, after said remittee connects to said server-based payment system to accept the pending transaction, trigger execution of said transaction, change account balances of the initiator's and the remittee's accounts accordingly, and assign an accepted status to said transaction.

15. A programmable user terminal, comprising an application program for communicating with a server-based payment system, the application program being programmed to perform, when executed by said programmable user terminal, the following actions:
initiate generation of an access token containing information about an identity and privileges associated with a social network user account pre-existing at a web-based communication platform by transmitting user credentials entered by a user into an input mask displayed to said user by said terminal;
receiving from said server-based payment system a processed contact list containing entries taken from a contact list belonging to said social network user account at said web-based communication platform and information indicative of whether corresponding payment service user accounts exist at said server-based payment system;
displaying to said user a menu for the selection of a payment remittee from said processed contact list; and
transmitting to said server-based payment system a payment order comprising information indicative of an entry selected from said processed contact list and an amount to be paid.

16. A computer readable storage medium comprising an application program for use at a user terminal for communicating with a server-based payment system, the application program being programmed, to perform, when executed by said programmable user terminal, the following actions:
initiate generation of an access token containing information about an identity and privileges associated with a social network user account pre-existing at a web-based communication platform by transmitting user credentials entered by a user into an input mask displayed to said user by said terminal;
receiving from said server-based payment system a processed contact list containing for entries for which corresponding payment service user accounts exist information indicative thereof;
displaying to said user a menu for the selection of a payment remittee from said processed contact list; and
transmitting to said server-based payment system a payment order comprising information indicative of an entry selected from said processed contact list and an amount to be paid.

17. A programmable user terminal, comprising an application program for communicating with a server-based payment system, the application program being programmed to perform, when executed by said programmable user terminal, the following actions:
performing a login with a web-based communication platform by transmitting user credentials entered by a user into an input mask displayed to said user by said terminal;
retrieving from said web-based communication platform a contact list belonging to a social network user account;
displaying to said user a menu for the selection of a payment remittee from said contact, list; and
transmitting to said server-based payment system a payment order comprising information indicative of an entry selected from said contact list, information indicative of said web-based communication platform and an amount to be paid.

18. A computer readable storage medium comprising an application program for use at a user terminal for communicating with a server-based payment system, the application program being programmed to perform, when executed by said programmable user terminal, the following actions:
performing a login with a web-based communication platform by transmitting user credentials entered by a user into an input mask displayed to said user by said terminal;
retrieving from said web-based communication platform a contact list belonging to a social network user account;
displaying to said user a menu for the selection of a payment remittee from said contact list; and
transmitting to said server-based payment system a payment order comprising information indicative of an entry selected from said contact list, information indicative of said web-based communication platform and an amount to be paid.
